(19) United States
(12) Patent Application Publication
(10) Pub. No.: US 2007/0272872 A1
(43) Pub. Date: Nov. 29, 2007

(54) X-ray detector with photodetector embedded in scintillator

(75) Inventors: Vladimir A. Joshkin, Madison, WI (US); Yacouba Diawara, Madison, WI (US); Roger D. Durst, Middleton, WI (US)

Correspondence Address: LAW OFFICES OF PAUL E. KUDIRKA, 40 BROAD STREET, SUITE 300, BOSTON, MA, 02109, US

(73) Assignee: Bruker AXS, Inc., Madison, WI (US)

(21) Appl. No.: 11/439,657

(22) Filed: May 24, 2006

(51) Int. Cl. G01T 1/20

(52) U.S. Cl. 250/370.11

(57) ABSTRACT

An X-ray detector includes one or more photodetectors embedded in scintillating material. The photodetectors may have a needle-like, a column-like, or a ridge-like structure. The scintillating material is applied over the photodetector which can either be a p−i−n type diode, an n−i−p type diode, a Schottky diode, or an avalanche diode.

### FIELD OF THE INVENTION

This invention relates to X-ray detectors and, more specifically, to a solid state detector having a vertical photodetector embedded into a scintillator layer.

### BACKGROUND OF THE INVENTION

Currently, X-ray technology is used for such purposes as X-ray mammography for early detection of breast cancer, x-ray diffraction and X-ray scanning of containers for security purposes. Historically, these X-ray images, particularly ones used for X-ray mammography, are performed with screen-film. The use of screen-film provides moderately high spatial resolution and contrast. As with many imaging technologies, the digitization of X-ray images has become known in the art.

Current digital X-ray imaging systems use X-ray imaging sensors that incorporate scintillation material. Scintillation material is a compound that emits detectable light upon absorption of X-ray or other high energy particles. Thus, scintillation means the generation of detectable light resulting from an X-ray or high energy particle.

Known Silicon-based X-ray imaging sensors, which incorporate Silicon photodetectors, suffer from low absorption efficiency of protons with energies over 8 keV in Silicon. As a result, there is a large attenuation length and low quantum efficiency of Silicon-based detectors for X-ray beams with wavelengths shorter than 1.5 Å.

Different approaches to solving these attenuation and low quantum efficiency problems have been proposed. In one proposal, an additional thick scintillating layer or scintillator crystal is applied in front of the photodetector active area. The scintillator has been made from materials with a density higher than that of Silicon to shorten the attenuation length and to allow for using relatively thin layers. The typical thickness of the scintillator, however, is still much thicker than 20 μm. Further, the scintillator has to be optically coupled to the Silicon photosensor and has to have high efficiency when converting X-ray photons into visual photons that will be more effectively absorbed by the Silicon photodetector.

Another method that attempts to improve performance uses the Silicon-based imaging sensors with thicker depleted regions, i.e., a thickness of over 300 μm.

Each of these methods has negative effects on the imaging sensor's performance. The additional thicker scintillator layer deteriorates the spatial resolution of the imager and decreases the output intensity of the converted optical signal, while the thicker depletion region worsens the spatial resolution and requires an application of a high bias potential, greater than 100 volts, that affects the device's reliability.

### SUMMARY OF THE INVENTION

In one embodiment, an X-ray detector comprises: a photodetector disposed on a first surface of a first layer of a first material, the photodetector extending substantially perpendicularly from the first surface and having a photodetector surface area; and a scintillator portion disposed over the photodetector, and in contact therewith over most of the photodetector surface area, wherein the scintillator portion substantially surrounds the photodetector.

The photodetector may comprise one of: a conical shape that tapers from its base to its tip, and wherein the base is adjacent the first surface; a substantially cylindrical shape with its long axis oriented substantially perpendicular to the first surface; and a substantially rectangular shape with its long axis oriented substantially perpendicular to the first surface.

The photodetector may be one of: a p−i−n photodiode; an n−i−p photodiode; an avalanche photodiode; and a Schottky photodiode.

One embodiment is directed to a method of manufacturing an X-ray detector, comprising: providing a first layer comprising a first material and having a first surface; providing a photodetector on the first surface, the photodetector extending substantially perpendicularly from the first surface and having a photodetector surface area; and providing material having scintillating properties directly on the photodetector to surround and cover substantially the entire photodetector surface area.

In another embodiment, an X-ray detector is provided, comprising: a first electrode comprising a first material; a plurality of photodetectors disposed on the first electrode, each of the photodetectors comprising the first material and each having a respective photodetector surface; a layer of scintillating material disposed over the plurality of photodetectors and in contact with each respective photodetector surface; and a second electrode disposed on the scintillating material layer.

### BRIEF DESCRIPTION OF THE DRAWINGS

The above and further advantages of the invention may be better understood by referring to the following description in conjunction with the accompanying drawings in which:

FIG. 1 is an illustration of one embodiment of the present invention;

FIGS. 2A and 2B are cross-sections of embodiments of the present invention;

FIG. 3 is a perspective view of one embodiment of the present invention;

FIGS. 4A and 4B are cross-sectional views of alternate embodiments of the present invention;

FIGS. 5A and 5B are cross-sections of yet another embodiment of the present invention; and

FIG. 6 is a schematic view of an alternate embodiment of the present invention.

### DETAILED DESCRIPTION

To overcome the inefficiencies of known X-ray detectors, in accordance with the present invention, photodiodes are embedded into a layer of scintillating material. Advantageously, optical coupling between the scintillator material and the photodetector is improved which increases the absorption efficiency of high energy X-ray photons. Various embodiments of the present invention will be described below in more detail.

The present invention is herein described, by way of example only, with reference to the accompanying drawings. It is stressed that the particulars shown are by way of example and for purposes of illustrative discussion of the various embodiments of the present invention only, and are presented in the cause of providing, what is believed to be, the most useful and readily understood description of the principles and conceptual aspects of the invention. In this regard, no attempt is made to show structural details of the invention in more detail than is necessary for a fundamental understanding of the invention. The description, taken with the drawings, makes apparent to those skilled in the art how the several forms of the invention may be embodied in practice.

Prior to explaining at least one embodiment of the present invention in detail, it is to be understood that the invention is not limited in its application to the details of construction and the arrangement of the components set forth in the following description or as illustrated in the drawings. The invention is capable of other embodiments or of being practiced or carried out in various ways. Also, it is to be understood that the phraseology and terminology employed herein are for the purpose of description and should not be regarded as limiting.

It is appreciated that certain features of the invention, which are, for the sake of clarity, described in the context of separate embodiments, may also be provided in combination in a single embodiment. Conversely, various features of the invention, which are, for brevity, described in the context of a single embodiment, may also be provided separately or in any suitable subcombination.

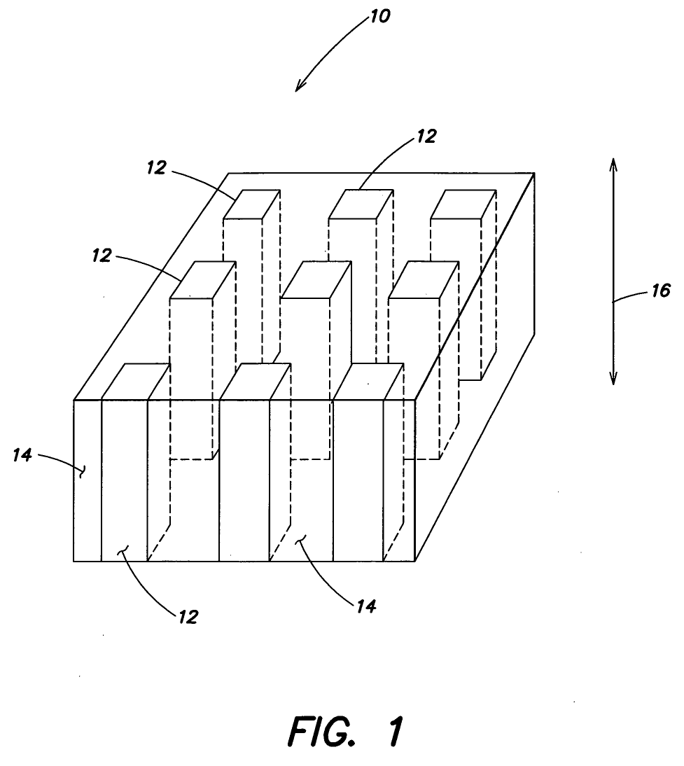

In accordance with one embodiment of the present invention, an X-ray detector 10 shown in FIG. 1, includes a plurality of photodetectors 12 embedded in a scintillating material 14. As shown, the photodetectors 12 are oriented “vertically,” that is, a long axis of the photodetector 12 is parallel to a symmetry axis 16 of the X-ray detector 10.

The photodetectors 12 can be semiconductor detectors, for example, p−i−n, n−i−p, Schottky or avalanche photodiodes. These photodiodes can be fabricated with standard dry and/or wet etching techniques on Silicon wafers as is known in the art. Further, the scintillating material 14 may be similarly deposited on the photodetectors 12 and can be fabricated by ways as known to one of ordinary skill in the art.

The photodetector 12 may be shaped to have a structure similar to that of a column or cylinder; that of a needle or cone; or similar to a ridge or rectangular block. Each of these configurations has a long axis that is oriented parallel to the symmetry axis 16 of the X-ray detector 10.

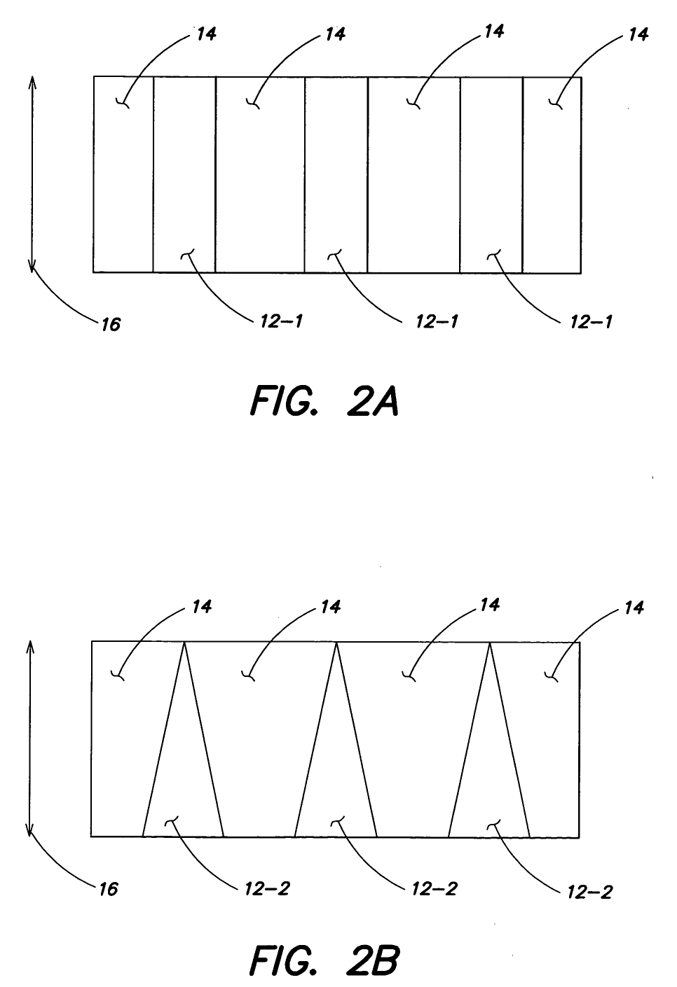

As shown in FIG. 2A, each of the photodetectors 12-1 in either a cylinder or rectangular block shape, would have a cross section as shown. A photodetector 12-2 having a needle or conical shape, is shown in cross-section in FIG. 2B.

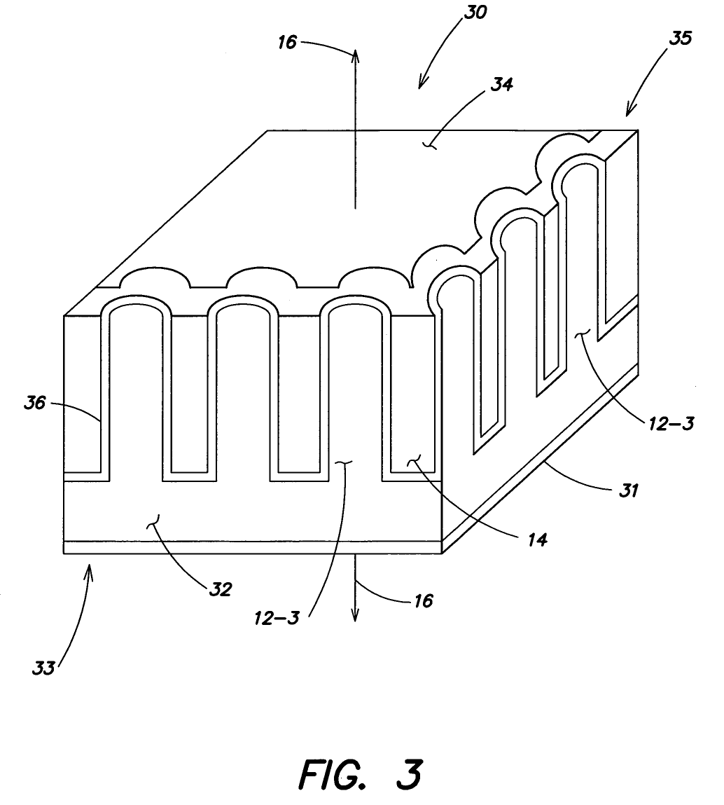

Referring now to FIG. 3, an alternate embodiment of an X-ray detector 30 is shown with column-like or cylindrical photodetectors 12-3 in an M×N array. The X-ray detector 30 includes a first electrode 33 which comprises a first metal or polysilicon contact layer 31 and a heavy doped layer 32, coupling the active area (intrinsic layer) of the photodetectors 12-3, and a second electrode 35 that comprises a heavy doped layer 36 and a second metal or polysilicon contact layer 34. The first and second contact layers 31, 34, as understood by those of ordinary skill in the art, would cover the respective surface of the X-ray detector 30, but the second contact layer 34 is shown in FIG. 3, for purposes of clarity, partially cut away. The heavy doped layers 32 and 36(n+ and p+ for the n−i−p and p+ and n+ for the p−i−n device, respectively) can be fabricated by any method as known to one of ordinary skill in the art. For example, the heavy doped layer 36 may be provided by deposition of the material on the surface or by doping the photodetector 12-3.

In one embodiment, the photodetectors 12-3 are p−i−n type photodetectors or photodiodes. In this embodiment, the first electrode 33 of the detector 30 comprises a heavy doped p-type Silicon (Si) layer 32, with the intrinsic layer 12-3, between the heavy doped layer 32 and the heavy doped region 36 which is a heavy doped n-type silicon layer. The scintillating material 14, which may be chosen from doped ZnSe, GaN, CdTe, Gd₂O₂S, La₂O₂S, Csl, YTaO₄, Y₂O₂S, ZnS, CaWO₄, BaFCl, BaSO₄, LaOBr, or other semiconductor materials with a direct bandgap larger than the bandgap of the Silicon, is deposited over and/or between the photodetectors 12-3 to, effectively, embed the photodetectors 12-3 within the scintillating material 14. The contact layer 34 of the second electrode 35 is then deposited over the “top” of the device 30 and would comprise either a metal or a heavy doped semiconductor. Thus, the first electrode 33 of the p−i−n photodiode operates as an anode and the second electrode 35 operates as a cathode.

For the complementary “n−i−p” photodiode, the foregoing p-type Silicon and n-type Silicon areas would be switched and thus the first electrode 33 would operate as a cathode and the second electrode 35 would operate as an anode.

For the Schottky diode, the heavy doped layer 36 of the second electrode is replaced with a metal layer, which is deposited directly on the semiconductor surface by ways as known to one of ordinary skill in the art.

While the X-ray detector 30 as shown in FIG. 3 was implemented with column-like or cylindrical photodiodes, it could be implemented with needle or conical photodiodes and/or ridge/rectangular block diodes or any combination of the three types. The second heavy doped layer (Schottky metal layer) could cover the device surface uniformly or with interruptions or with a lateral gradient as well. For example, the Schottky contact could be placed on top of photodiode columns 12-3 only. The remaining “opened” side walls of the columns could be passivated by a deposition of a dielectric or material with wide band gap layers using ordinary microelectronic technologies.

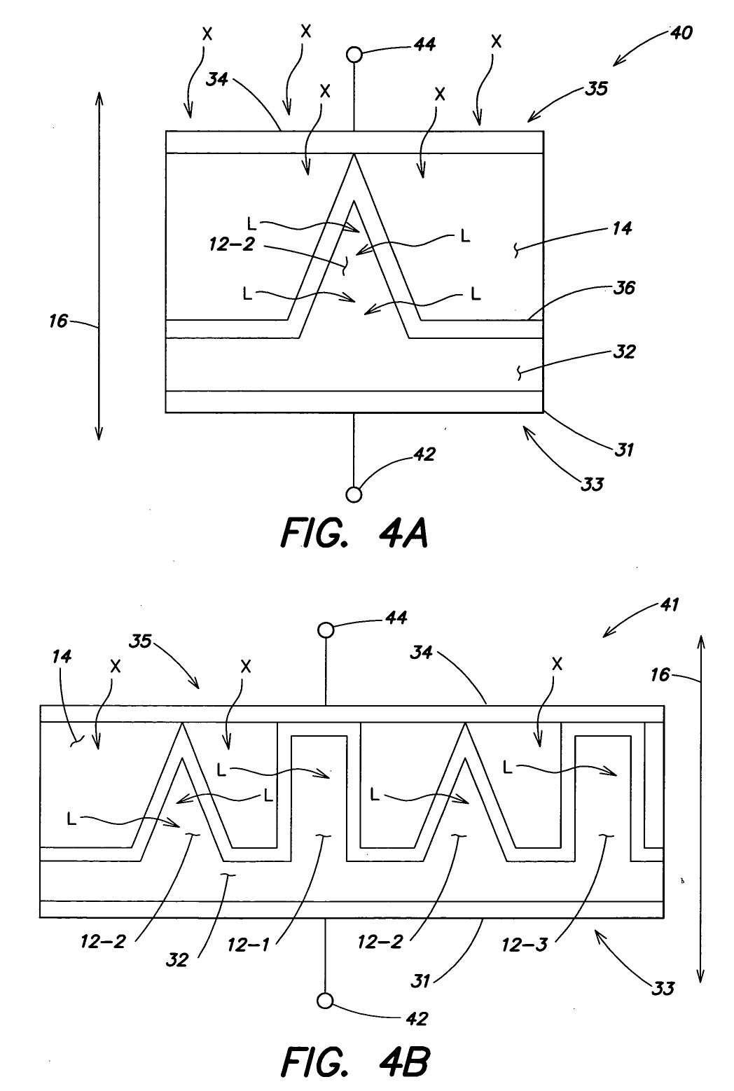

As shown in FIG. 4A, an X-ray detector 40, in accordance with another embodiment of the present invention, includes a needle-like photodetector which comprises intrinsic layer 12-2, a first electrode 33 and a second electrode 35 that comprises a heavy doped region 36 and metal contact layer 34. The detector 40 has a first output (terminal 42), which is coupled to the first electrode 33 in accordance with any one of a number of different technologies, for example, metal ohmic contact technology, as is known to one of ordinary skill in the art. Similarly, a second output (terminal 44) is coupled to the second contact layer 34 or to the heavy doped layer 36 directly.

In operation, X-rays (X) impinge on the X-ray detector 40, either passing through the second ultrathin contact layer 34 (e.g., a 10 nm thick metal layer), and into the scintillating material 14 or directly into the scintillating material 14 for an embodiment with a pixel-structured second contact layer. In one embodiment, the symmetry axis 16 is oriented substantially parallel to the direction of the X-rays (X). When the X-rays (X) enter the scintillating material 14, the X-ray photons are converted into visible light (L) and are directed into the photodetecting area 12-2. The converted light (L) from the scintillating material 14 irradiates the photodetector 12-2 in a direction that is substantially perpendicular to the symmetry axis 16. As a result of this orientation, the active area of the photodetector 12-2 is proportional to a distance between the first electrode 33 and contact layer 34 of the second electrode 35. The sensitivity, i.e., the quantum efficiency, and the resolution of the detector 40 does not, therefore, decrease as a thickness of the scintillating material increases.

As is known to one of ordinary skill in the art, an active area of the photodetector 12-2 would be depleted by a reverse bias potential applied between the first and second contact layers 31, and 34, i.e., along the anode-cathode axis 16. Additionally, the active area of the photodetector 12 is partially depleted by a built-in bias that occurs due to variation of the doping level in layers 32 and 36, and by the same external reverse bias potential applied between layers 32 and 36 in a direction perpendicular to the symmetry axis 16. As a result, the area 12-2 can be depleted at a lower bias voltage level because the dimension of the device, i.e., in a perpendicular direction relative to the axis 16, is much smaller, on the order of one to three times smaller, than the device dimension along the axis of symmetry 16. As a non-limiting example, a needle structure with a length of 10 μm and an acceptor concentration Na of ˜10¹⁶ cm⁻³ might be completely depleted with a bias voltage in the range of 10 to 30 volts. The silicon columns with a diameter of ˜2 um and an acceptor concentration Na of ˜10^{16 cm}⁻³; and a thickness of the n-type surface layer of ˜0.9 um with a donor concentration Nd of ˜10¹⁵ cm⁻³, will be mostly depleted at room temperature due to only built-in potential, without the application of an external bias potential (depletion width of such a p−n junction is ˜0.97 um at thermal equilibrium). This is advantageous as the ratio of surface to bulk is changed and the more surface area there is, the easier it is to deplete.

The output from the photodetector 12-2, which can operate either in a photocurrent or a photovoltaic mode of operation, is a differential signal between the first output 42 and the second output 44, in accordance with operation as is known to one of ordinary skill in the art.

As shown in FIG. 4A, the X-ray detector 40 incorporates a single photodetector with active area 12-2 to detect the X-rays impinging upon the detector 40. It should also be noted that while a needle-like photodetector is represented in the foregoing discussion with regard to the X-ray detector 40, the columnar or ridge shaped structures could also be implemented as well. In addition, the photodetector could be of the n−i−p, p−i−n, Schottky or avalanche construction.

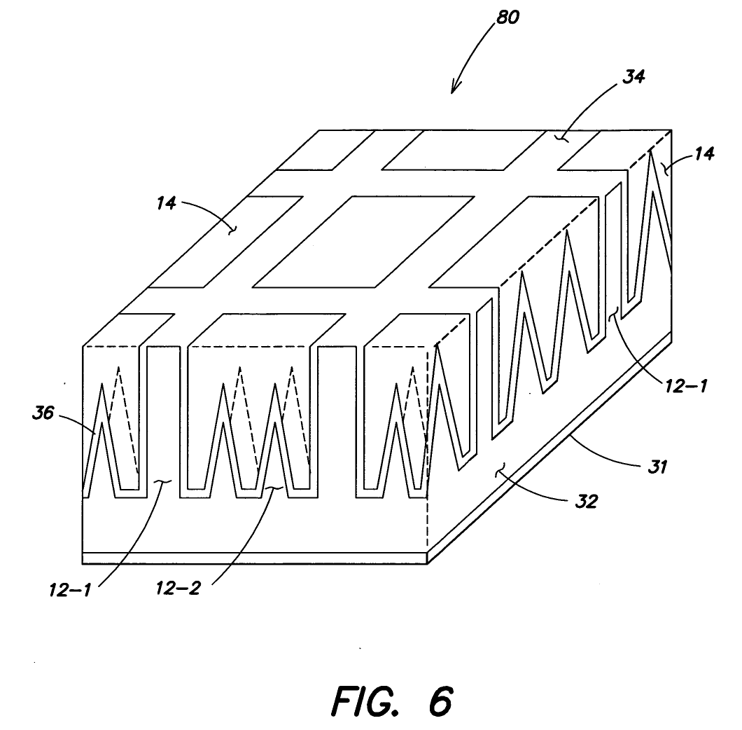

In an alternate embodiment, a plurality of photodetectors may be provided where an output signal is the accumulation of the signals from the plurality of photodetectors. As shown in FIG. 4B, a cross section of an X-ray detector 41 is represented as having a total of four photodetectors including, for purposes of explanation only, two needle-like structures, one column or cylindrical structure and one block or ridge type structure. The operation of the device 41 is similar to that described above with regard to the device 40. The device 41 might have a mosaic or pixel-like read-out scheme with separate output terminals for each detector or for a group of them. The insulation between the separate detectors can be created using standard technologies of pixel and strip detectors. It should be noted that the second contact layer, i.e., layer 34, does not need to be continuous even if it produces a read-out for the group of the detectors. For example, the detector structure 80, as shown in FIG. 6, can provide the read-out by fabricating the second metal contact layer 34 on top of only the ridges 12-1. The heavy doped layer 36 on the needle-like diodes 12-2 provides electrical contact to, for example, read-out terminals for the rest of the area in this case. The first electrode 33 can be patterned, e.g., by the selective doping thereof, to produce pixel-like or strip-like imagers.

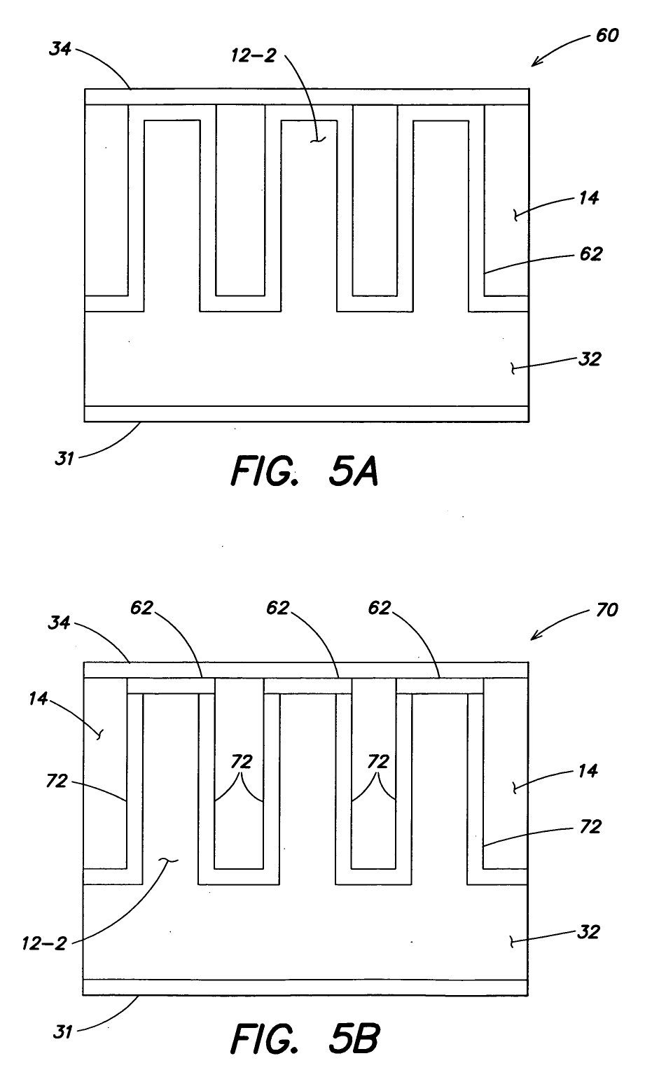

While the foregoing embodiments have been described with regard to a “p−i−n” or “n−i−p” photodiode, a Schottky photodiode may also be implemented. In accordance with yet another embodiment of the present invention, an X-ray detector 60 includes completely or partially depleted active area 12-2, as shown in FIG. 5A. A Schottky metal layer 62 is disposed on the photodiode surface. The Schottky metal layer 62, when thinner than 100 Å, minimizes the absorption of photons in the metal layer. The top contact layer 34 could be up to 0.1 μm thick depending on a metal attenuation length and the energy of the x-ray photon. In one embodiment, composites that comprise optically transparent ionic materials with high conductivity and scintillating nano- or microparticles can be used as the scintillator 14 and the Schottky metal contact 62 at the same time. In yet another embodiment, the second contact layer 34 may not need to cover the entire top surface of the X-ray detector 60 as the metal surface diode may serve this purpose. The Schottky diode may also be provided with the needle, column or ridge-like structure.

In an alternate embodiment of the Schottky diode implementation, as shown in FIG. 5B, the metal layer 62 may not cover the entire needle, column or ridge structure through to the bottom. In this embodiment, in order to minimize a leakage current, the unmetalized surfaces 72 can be passivated by the deposition of SiN, SiO₂ or wide bandgap semiconductor layers prior to the deposition of the scintillating material 14.

In the foregoing embodiments, the scintillating material 14 may be deposited by implementation of any one or more known methods used for such deposition. These methods include, but are not limited to: painting; sedimentation; slurry; spraying; high vacuum deposition (MBE, MOMBE, e-beam, atomic layer epitaxy); magnetron sputtering; laser ablation; metalorganic chemical vapor deposition (MOCVD); and plasma enhanced chemical vapor deposition (PECVD).

Further, the X-ray photodetectors described herein can be used in connection with, or as, X-ray pixel detectors, strip detectors, CCD and CMOS imagers, drift detectors, proportional detectors and single sensors.

In yet another embodiment, doped ZnSe, GaN, CdTe or other semiconductor materials with a direct bandgap larger than the bandgap of the Silicon can be used as the scintillating material 14 and the cathode (or anode if a n−i−p device) without the need for a separately deposited cathode (or anode).

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. An X-ray detector, comprising:
a photodetector disposed on a first surface of a first layer of a first material, the photodetector extending substantially perpendicularly from the first surface and having a photodetector surface area; and
a scintillator portion disposed over the photodetector, and in contact therewith over most of the photodetector surface area,
wherein the scintillator portion substantially surrounds the photodetector.

2. The X-ray detector of claim 1, wherein the photodetector comprises one of:
a conical shape that tapers from its base to its tip, and wherein the base is adjacent the first surface;
a substantially cylindrical shape with its long axis oriented substantially perpendicular to the first surface; and
a substantially rectangular shape with its long axis oriented substantially perpendicular to the first surface.

3. The X-ray detector of claim 1, wherein the photodetector is one of:
a p−i−n photodiode;
an n−i−p photodiode;
an avalanche photodiode; and
a Schottky photodiode.

4. The X-ray detector of claim 1, wherein the photodetector comprises Si.

5. The X-ray detector of claim 4, wherein the scintillator portion comprises material having a direct bandgap value that is greater than a bandgap value of Si.

6. The X-ray detector of claim 1, wherein:
the first material comprises impurities of a first type; and
an outer surface layer of the photodetector comprises impurities of a second type different from the first type.

7. The X-ray detector of claim 6, wherein:
the impurities of the first type are one of p-type Si and n-type Si; and
the impurities of the second type are the other of p-type Si and n-type Si.

8. The X-ray detector of claim 1, wherein the photodetector further comprises an outer surface layer, on the photodetector surface area, comprising a metal.

9. The X-ray detector of claim 8, wherein the metal outer layer covers substantially the entire photodetector.

10. The X-ray detector of claim 8, wherein:
the metal outer layer does not cover the entire photodetector; and
where the photodetector is not covered by the metal outer layer, the photodetector is passivated by at least one of:
deposition of a wide bandgap semiconductor material;
by deposition of a dielectric material; and
by heavy doping.

11. The X-ray detector of claim 8, wherein a thickness of the metal of the outer surface layer is less than 100 Å.

12. The X-ray detector of claim 1, further comprising an outer surface layer comprising a second material disposed on the photodetector surface.

13. The X-ray detector of claim 12, wherein:
the first material is not the same as the second material.

14. The X-ray detector of claim 13, wherein:
the first material is one of p-type Si and n-type Si; and
the second material is the other of p-type Si and n-type Si.

15. A method of manufacturing an X-ray detector, comprising:
providing a first layer comprising a first material and having a first surface;
providing a photodetector on the first surface, the photodetector extending substantially perpendicularly from the first surface and having a photodetector surface area; and
providing material having scintillating properties directly on the photodetector to surround and cover substantially the entire photodetector surface area.

16. The method of claim 15, wherein providing the photodetector comprises:
depositing an amount of first material to form the photodetector as one of:
a cylindrical structure;
a rectangular block structure; and
a conical structure having a base adjacent the first surface.

17. The method of claim 15, further comprising:
depositing a layer of metal on the photodetector surface area.

18. The method of claim 17, further comprising:
depositing the metal layer on substantially the entire photodetector surface area.

19. The method of claim 17, wherein a thickness of the deposited metal layer is less than 2000 Å.

20. The method of claim 17, further comprising:
depositing the metal layer on less than the entire photodetector surface area; and
where the photodetector surface area is not covered with the metal layer, passivating the photodetector surface area by at least one of:
deposition of a wide bandgap semiconductor material;
by deposition of a dielectric material; and
by heavy doping.

21. The method of claim 20, wherein the heavy doping material is one of P, As, N, Sb, C, B and Al.

22. An X-ray detector, comprising:
a first electrode comprising a first material;
a plurality of photodetectors disposed on the first electrode, each of the photodetectors comprising the first material and each having a respective photodetector surface;
a layer of scintillating material disposed over the plurality of photodetectors and in contact with each respective photodetector surface; and
a second electrode disposed on the scintillating material layer.

23. The X-ray detector of claim 22, wherein each photodetector comprises one of:
a conical structure extending from the first electrode;
a cylindrical structure; and
a rectangular block structure.

24. The X-ray detector of claim 22, wherein each photodetector surface comprises a layer of a second material different from the first material.

25. The X-ray detector of claim 24, wherein the second electrode comprises the second material.

26. The X-ray detector of claim 25, wherein:
the first material is one of n-type Si and p-type Si; and
the second material is the other of n-type Si and p-type Si.

27. The X-ray detector of claim 24, wherein the second material comprises a metal.

28. The X-ray detector of claim 27, wherein a thickness of the metal layer is less than 100 Å.

29. The X-ray detector of claim 28, wherein the metal layer covers substantially the entire respective photodetector surface.

30. The X-ray detector of claim 28, wherein the metal layer does not cover the entire respective photodetector surface; and
where the respective photodetector surface is not covered by the metal layer, the photodetector surface is passivated by placement of a wide bandgap semiconductor material, or by deposition of a dielectric material, or by heavy doping.
